(19) United States
(12) Patent Application Publication
(10) Pub. No.: US 2009/0111537 A1
(43) Pub. Date: Apr. 30, 2009

(54) MOBILE TERMINAL DEVICE

(75) Inventors: Seiji Fujimoto, Yokohama-shi (JP); Hidehiro Yanagibashi, Yokohama-shi (JP)

Correspondence Address: Christensen O'Connor Johnson Kindness PLLC, 1420 5th Avenue, Suite 2800, Seattle, WA, 98101, US

(73) Assignee: MATSUSHITA ELECTRIC INDUSTRIAL CO., LTD., Osaka (JP)

(21) Appl. No.: 12/240,731

(22) Filed: Sep. 29, 2008

(30) Foreign Application Priority Data
Oct. 26, 2007 (JP) 2007-278563

(51) Int. Cl. H04M 1/02

(52) U.S. Cl. 455/575.3

(57) ABSTRACT

In a foldable mobile terminal device, a first housing is connected to a second housing via a connecting portion. The mobile terminal device includes: a first hinge shaft for opening/closing the second housing together with the connecting portion in a longitudinal direction; a second hinge shaft for opening/closing the second housing in a lateral direction; a call clearing button disposed on a second hinge shaft side of an upper surface of the first housing as seen from a lateral center of the upper surface; and a first projection for button identification which is provided on an edge portion of the second hinge shaft side and lies lateral to the call clearing button wherein a height of the first projection is made lower than a height of the upper surface of the first housing.

### BACKGROUND OF THE INVENTION

1. Technical Field

The present invention relates to a mobile terminal device and more particularly to a mobile telephone device, PDA (Personal Digital Assistant), PHS (Personal Handy-phone System) and the like in which a position of a call clearing button or a call button is made to be identified easily.

### BACKGROUND ART

In conventional fixed telephone devices, a projection is provided on a surface of a No. 5 key in dialing keys so as to facilitate the identification of the position by a tip of a finger being allowed to touch the projection. In addition, in mobile telephone devices which have quickly been used generally in these days, those having similar projections on surfaces of a No. 5 key and other operation buttons have been put in practical use. When projections are provided on surfaces of dialing buttons and other operation buttons, it will be easy to locate the buttons and hence be convenient in operating the buttons.

A mobile telephone device includes a so-called “talking key” or “call button” which starts a talk and a so-called “talk terminating key” or “call clearing button” which terminates a talk. Then, it has been proposed to provide differently shaped projections on the call button and the call clearing button as is shown in a conventional mobile telephone device 60 depicted in FIG. 19. In the mobile telephone device 60, an angularly raised projection 62 is provided on a call button 61 on a so-called straight type housing which has a straight rectangular parallelepiped shape. Similarly, a thin disc-shaped projection 64 is provided on a call clearing button 63. A perspective view of the angularly raised projection 62 is shown in FIG. 20A. A perspective view of the thin disc-shaped projection 64 is shown in FIG. 20B (for example, refer to Patent Document 1).

In the event that the differently shaped projections are present on the call button and the call clearing button in the way described above, the call button and the call clearing button are conveniently pressed quickly in an ensured fashion. In particular, in case the call clearing button is pressed as quickly after the end of an actual voice communication as possible, a time from the end of the voice communication until the cutting off of the telephone line can be shortened. When the usage of a mobile telephone device is charged second by second, the charge can be saved by pressing the call clearing button as quickly as possible.

On the other hand, foldable mobile telephone devices having a dual-shaft hinge in which a “longitudinal opening” and “lateral opening” of a housing on which a display is present (a so-called longitudinal and lateral opening type) are known (for example, refer to Patent Document 2).

In addition, mobile telephone devices of a so-called slide type in which a housing on which a display is present slides over a housing on which a control part is present are known (for example, refer to Patent Document 3).

| | |
|---|---|
| [Patent Document 1] | JP-A-10-136072 |
| [Patent Document 2] | JP-A-2007-113686 |
| [Patent Document 3] | JP-A-2001-292213 |

However, there have been problems which will be described below when the projections on the call button and the call clearing button which are described in Patent Document 1 are attempted to be applied to the mobile telephone device of the so-called longitudinal and lateral opening type described in Patent Document 2 and the mobile telephone device of the so-called slide type described in Patent Document 3.

FIGS. 21 and 22 show exemplary diagrams showing an example in which the projections on the call button and the call clearing button which are described in Patent Document 1 are applied to a so-called longitudinal and lateral opening mobile telephone device like the one described in Patent Document 2. In a foldable mobile telephone device having a dual-shaft hinge, as is shown in FIGS. 21 and 22, in which a “longitudinal opening” and “lateral opening” of a housing on which a display 76 is present, that is, the housing can be opened both in longitudinal and lateral directions, in the event that an angularly raised projection 72 is provided on a call button 71 and a thin disc-shaped projection 74 is provided on a call clearing button 73, when the housing is opened in the lateral direction, there will be a problem that the thin disc-shaped projection 74 touches a second housing 77 to thereby obstruct the lateral opening of the housing.

FIG. 21 shows a perspective view showing an external appearance of the foldable mobile telephone device 70 having a dual-shaft hinge which results when the second housing 77 on which the display 76 is present is opened in a longitudinal direction. In addition, FIG. 22 shows an external appearance of the dual-shaft hinged foldable mobile telephone device 70 which results when the second housing 77 is opened in a lateral direction. In the foldable mobile telephone device 77, the second housing 77 is opened on a first hinge shaft 78 in a direction indicated by an arrow A, that is, in the longitudinal direction. In addition, the second housing 77 is opened on a second hinge shaft 70 in a direction indicated by an arrow B, that is, in the lateral direction.

In the foldable mobile telephone device 70, in the event that the angularly raised projection 72 is provided on the call button 71 and the thin disc-shaped projection 74 is provided on the call clearing button 73, although there will be no problem in the longitudinal opening shown in FIG. 21, in the lateral opening shown in FIG. 22, the thin disc-shaped projection 74 touches the second housing 77 to thereby obstruct the lateral opening. In addition, there will be some cases in which the thin disc-shaped projection touches the second housing 77 and thereby cause damage to the second housing 77. In the event that the height of the thin disc-shaped projection 74 is lowered, there will be a problem that the projection 74 becomes difficult to be identified.

In addition, FIG. 23 shows an exemplary diagram showing an example in which the projections on the call button and the call clearing button which are described in Patent Document 1 are applied to a mobile telephone device of a so-called sliding type like the one described in Patent Document 3. In a mobile telephone device as is shown in FIG. 23, a second housing 87 on which a display 86 is present slides over a first housing 85 on which a control part is present in directions indicated by arrows C. In the sliding type mobile telephone device shown in FIG. 23, in the event that an angularly raised projection 82 is provided on a call button 81 and a thin disc-shaped projection 84 is provided on a call clearing button 83, a certain gap is necessary so that a lower surface of the second housing 87 which slides in the directions indicated by the arrows C is not brought into contact with the projections 82, 84. However, it is difficult to take a sufficient gap in the sliding type mobile telephone device 80 whose thickness is thin. In the event that the gap is narrow, there will be a problem that the lower surface of the second housing 87 is brought into contact with the projections 82, 84.

### SUMMARY OF THE INVENTION

The invention has been made in view of these situations, and an object thereof is to provide a mobile telephone device in which projections provided to identify a call button and a call clearing button do not obstruct opening when applied to a so-called longitudinal and lateral opening mobile telephone device or a sliding mobile telephone device and are easy to be touched to identify the call button and the call clearing button quickly in an ensured fashion.

With a view to attaining the object, according to a first aspect of the invention, there is provided a foldable mobile terminal device in which a first housing is connected to a second housing via a connecting portion, including: a first hinge shaft for opening/closing the second housing together with the connecting portion in a longitudinal direction; a second hinge shaft for opening/closing the second housing in a lateral direction; a call clearing button disposed on a second hinge shaft side of an upper surface of the first housing as seen from a lateral center of the upper surface; and a first projection for button identification which is provided on an edge portion of the second hinge shaft side and lies lateral to the call clearing button wherein a height of the first projection is made lower than a height of the upper surface of the first housing.

According to the configuration described above, when the second housing rotates on the shaft which is parallel to the longitudinal direction thereof, since the first projection is provided in the position which lies lower than the height of the upper surface of the first housing, there occurs no situation in which the first projection disposed laterally of the call clearing button touches the second housing to thereby obstruct the opening of the second housing. In addition, when the second housing rotates on the shaft which is parallel to the lateral direction thereof, since the first projection disposed laterally of the call clearing button can easily be touched, the call clearing button can be pressed quickly in an ensured fashion. In addition, even though the call clearing button cannot be visualized well as when attempting to switch on the mobile telephone device at night or in a dark place, since the first projection is provided at the edge portion which is the edge portion of the upper surface of the first housing, the first projection lying lateral to the call clearing button can easily be touched, and therefore, the call clearing button can quickly be pressed in the ensured fashion so as to switch on the mobile telephone device quickly.

In addition, according to a second aspect of the invention, the mobile terminal device includes a call button disposed on an opposite side of the second hinge shaft side of the upper surface as seen from the lateral center of the upper surface and a second projection for button identification which is provided on the opposite side of the second hinge shaft side and lies lateral to the call button.

According to the configuration described above, since the first projection is provided on the edge portion which constitutes the edge portion of the upper surface of the first housing in the position which lies lower than the height of the upper surface of the first housing, while the second projection is provided on the upper surface of the first housing, the first projection lying lateral to the call clearing button and the second projection lying lateral to the call button can easily be discriminated or identified.

Furthermore, according to a third aspect of the invention, in the mobile terminal device, the first housing has an inclined surface formed at the edge portion, and the first projection is provided on the inclined surface.

According to the configuration described above, since the first projection can be provided on the edge portion which constitutes the edge portion of the upper surface of the first housing in the position lying lower than the height of the upper surface of the first housing, there occurs no situation in which the first projection disposed laterally of the call clearing button touches the second housing to thereby obstruct the opening thereof. In addition, when the second housing rotates on the shaft which is parallel to the lateral direction thereof, since the first projection lying lateral to the call clearing button can easily be touched, the call clearing button can quickly be pressed in the ensured fashion.

According to a fourth aspect of the invention, in the mobile terminal device, the first housing has a stepped portion formed at the edge portion, and the first projection is provided on the stepped portion.

According to the configuration described above, since the first projection can be provided on the edge portion which constitutes the edge portion of the upper surface of the first housing in the position lying lower than the height of the upper surface of the first housing, there occurs no situation in which the first projection disposed laterally of the call clearing button touches the second housing to thereby obstruct the opening thereof. In addition, when the second housing rotates on the shaft which is parallel to the lateral direction thereof, since the first projection lying lateral to the call clearing button can easily be touched, the call clearing button can quickly be pressed in the ensured fashion.

According to a fifth aspect of the invention, in the mobile terminal device, the first housing has a curved surface portion formed at the edge portion, and the first projection is provided on the curved surface portion.

According to the configuration described above, since the first projection can be provided on the edge portion which constitutes the edge portion of the upper surface of the first housing in the position lying lower than the height of the upper surface of the first housing, there occurs no situation in which the first projection disposed laterally of the call clearing button touches the second housing to thereby obstruct the opening thereof. In addition, when the second housing rotates on the shaft which is parallel to the lateral direction thereof, since the first projection lying lateral to the call clearing button can easily be touched, the call clearing button can quickly be pressed in the ensured fashion.

According to a sixth aspect of the invention, there is provided a foldable mobile terminal device in which a first housing is connected to a second housing via a connecting portion, including: a first hinge shaft for opening/closing the second housing together with the connecting portion in a longitudinal direction; a second hinge shaft for opening/closing the second housing in a lateral direction; a call button disposed on a second hinge shaft side of an upper surface of the first housing as seen from a lateral center of the upper surface; and a projection for button identification which is provided on an edge portion of the second hinge shaft side and lies lateral to the call button wherein a height of the first projection is made lower than a height of the upper surface of the first housing.

According to the configuration described above, when the second housing rotates on the shaft which is parallel to the longitudinal direction thereof, since the projection is provided in the position lying lower than the height of the upper surface of the first housing, there occurs no situation in which the projection lying lateral to the call button touches the second housing to thereby obstruct the opening thereof. In addition, when the second housing rotates on the shaft which is parallel to the lateral direction thereof, the projection lying lateral to the call button can easily be touched, and hence, the call button can quickly be pressed in the ensured fashion.

Furthermore, according to another aspect of the invention, there is provided a foldable mobile terminal device in which a first housing is connected to a second housing via a connecting portion, including: a first hinge shaft for opening/closing the second housing together with the connecting portion in a longitudinal direction; a second hinge shaft for opening/closing the second housing in a lateral direction; a call clearing button disposed on an upper surface of the first housing; a call button disposed on the upper surface of the first housing; and a projection for button identification provided on an edge portion of the upper surface of the first housing, wherein the call clearing button, the call button and the projection are disposed on a straight line in a lateral direction; and wherein the projection is provided on the edge portion which lies at a side of the upper surface where the call clearing button is provided wherein a height of the projection is made lower than a height of the upper surface of the first housing.

According to the configuration described above, since the projection is provided in the position lying lower than the height of the upper surface of the first housing, there occurs no situation in which the projection lying lateral to the call clearing button obstructs the opening of the second housing, and since the projection lying lateral to the call clearing button can easily be touched, the call clearing button can quickly be pressed in the ensured fashion.

According to the aspects of the invention, since the projection is provided in such a manner as to be lower than the height of the upper surface of the first housing, there occurs no situation in which the projection lying lateral to the call clearing button or the call button obstructs the opening of the second housing, and since the projection lying lateral to the call clearing button or the call button can easily be touched, the call clearing button or the call button can quickly be pressed in the ensured fashion.

### BRIEF DESCRIPTION OF THE DRAWINGS

The above objects and advantages of the present invention will become more apparent by describing in detail preferred exemplary embodiments thereof with reference to the accompanying drawings, wherein like reference numerals designate like or corresponding parts throughout the several views, and wherein:

FIG. 1 is a perspective view showing a state in which a housing of a mobile telephone device according to Embodiment 1 of the invention is opened longitudinally;

FIG. 2 is a perspective view showing a state in which the housing of the mobile telephone device according to Embodiment 1 of the invention is opened longitudinally;

FIG. 3 is a perspective view showing a state in which the housing of the mobile telephone device according to Embodiment 1 of the invention is opened laterally;

FIG. 4 is a sectional view of a first housing of the mobile telephone device according to Embodiment 1 of the invention;

FIG. 5 is a partial sectional view of the first housing of the mobile telephone device according to Embodiment 1 of the invention;

FIG. 6 is a conceptual diagram showing a state in which the housing of the mobile telephone device according to Embodiment 1 of the invention is gripped by the left hand;

FIG. 7 is a sectional view which results when the housing of the mobile telephone device according to Embodiment 1 of the invention is opened laterally;

FIG. 8 is a partial sectional view which results when the housing of the mobile telephone device according to Embodiment 1 of the invention is opened laterally;

FIG. 9 is a sectional view which results when the housing of the mobile telephone device according to Embodiment 1 of the invention is opened laterally;

FIG. 10 is a partial sectional view which results when the housing of the mobile telephone device according to Embodiment 1 of the invention is opened laterally;

FIG. 11 is a perspective view showing a state in which a housing of another mobile telephone device according to Embodiment 1 of the invention is opened laterally;

FIG. 12 is a sectional view which results when the housing of the mobile telephone device according to Embodiment 1 of the invention which is shown in FIG. 11 is opened laterally;

FIG. 13 is a perspective view of a mobile telephone device according to Embodiment 2 of the invention;

FIG. 14 is a perspective view of a mobile telephone device according to Embodiment 3 of the invention;

FIG. 15 is a sectional view of a housing of a mobile telephone device according to Embodiment 4 of the invention;

FIG. 16 is a perspective view of part of the mobile telephone device according to Embodiment 4 of the invention;

FIG. 17 is a sectional view of a housing of a mobile telephone device according to Embodiment 5 of the invention;

FIG. 18 is a perspective view of part of the mobile telephone device according to Embodiment 5 of the invention;

FIG. 19 is a perspective view of a conventional straight mobile telephone device;

FIG. 20A is a perspective view showing an external shape of a projection attached to a call button of the conventional mobile telephone device;

FIG. 20B is a perspective view showing an external shape of a projection attached to a call clearing button of the conventional mobile telephone device;

FIG. 21 is an exemplary diagram showing a case where projections on a call button and a call clearing button which are described in Patent Document 1 are applied to a so-called longitudinal and lateral opening mobile telephone device as described in Patent Document 2 (a state in which the mobile telephone device is opened longitudinally);

FIG. 22 is an exemplary diagram showing a case where the projections on the call button and the call clearing button which are described in Patent Document 1 are applied to the so-called longitudinal and lateral opening mobile telephone device as described in Patent Document 2 (a state in which the mobile telephone device is opened laterally); and

FIG. 23 is an exemplary diagram showing a case where the projections on the call button and the call clearing button which are described in Patent Document 1 are applied to a so-called sliding mobile telephone device as described in Patent Document 3.

### DETAILED DESCRIPTION OF THE PREFERRED EMBODIMENTS

Preferred embodiments for carrying out the present invention will be described with reference to accompanying figures.

### Embodiment 1

As a mobile telephone device of Embodiment 1 of the invention, a foldable mobile telephone device (or a mobile telephone device of a so-called longitudinal and lateral opening type) having a dual-shaft hinge will be described in which a “longitudinal opening” and “lateral opening” of a housing on which a display is present can be implemented, that is, the housing can be opened both in longitudinal and lateral directions.

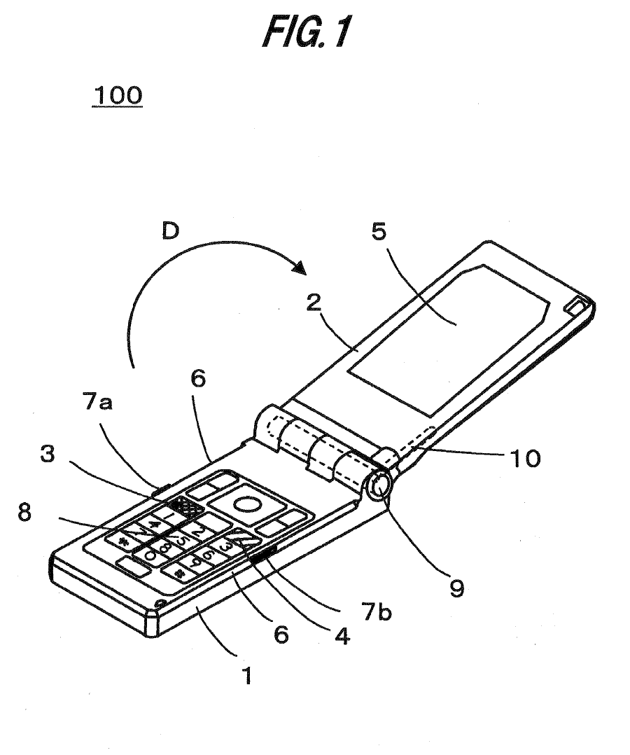

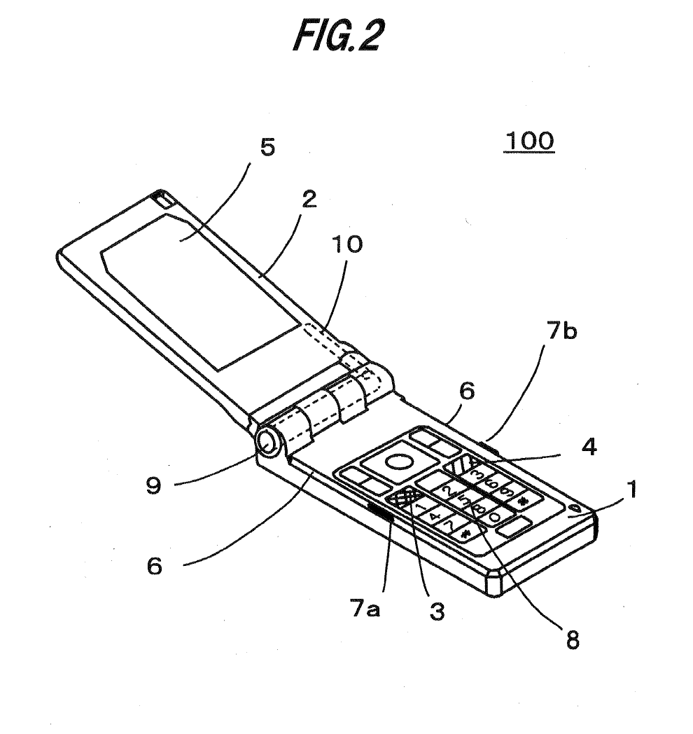

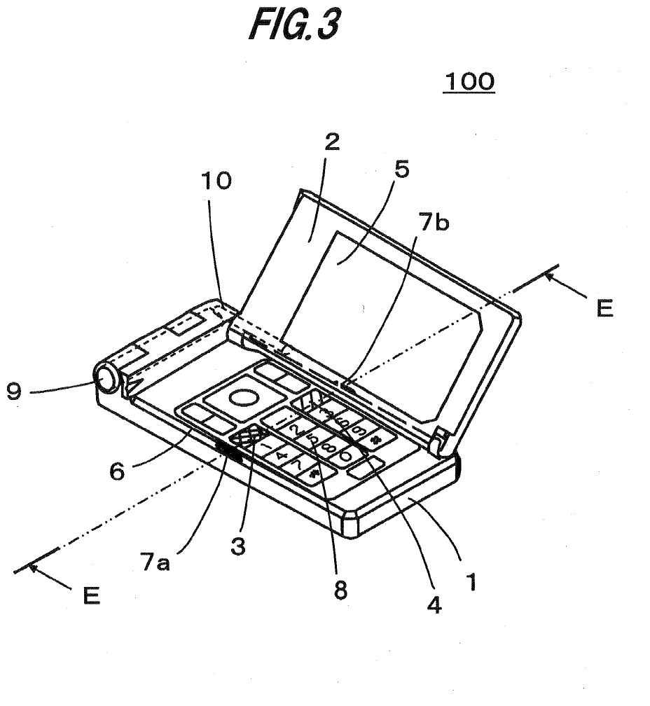

FIGS. 1 and 2 are perspective views showing external appearances of a mobile telephone device 100 according to Embodiment 1 of the invention which results when a second housing 2 is opened from bottom to top or in a longitudinal direction. FIG. 1 is a perspective view of the mobile telephone device 100 as viewed obliquely from a top right-hand side position, and FIG. 2 is a perspective view of the mobile telephone device 100 as viewed from a top left-hand side position. FIG. 3 is a perspective view showing an external appearance of the mobile telephone device 100 which results when the second housing 2 is opened from side to side or laterally. As is shown in FIGS. 1 and 2, in the mobile telephone device 100, a first housing 1 and the second housing 2 are connected together by a connecting portion which is made up of a first hinge shaft 9 and a second hinge shaft 10. Here, the first hinge shaft 9 is a shaft which is parallel to a lateral direction of the first housing 1 or the second housing 2. The second hinge shaft 10 is a shaft which is parallel to a length or longitudinal direction of the first housing or the second housing 2. In addition, the connecting portion connects together the first housing 1 and the second housing 2 in such a manner as to rotate on the two shafts.

A talking key or call button 3 which is used when making or receiving a phone call, a talk terminating or call clearing button 4 which is used when terminating a talk or respective functions and dialing buttons 8 which are used when inputting telephone numbers and characters are disposed on the first housing 1. (Hereinafter, a surface of the first housing 1 on which at least the call button 3 and the call clearing button 4 are disposed will be referred to as an upper surface of the first housing 1.) In addition, a display 5 is disposed on the second housing 2.

The mobile telephone device 100 can be put into three states such as a folded state in which the call button 3 or the call clearing button 4 on the first housing confronts the display 5 of the second housing 2 (a state in which the second housing is folded onto the first housing), a longitudinally opened state in which the second housing has rotated on the shaft which is parallel to the width direction thereof (the first hinge shaft 9) from the folded state in a direction indicated by an arrow D to thereby be positioned spaced away from the first housing (a state in which the second housing has been opened in the longitudinal direction) (a state shown in FIGS. 1 and 2), and a laterally opened state in which the second housing has rotated on the shaft which is parallel to the longitudinal direction thereof (the second hinge shaft 10) from the folded state to thereby be positioned spaced away from the first housing (a state in which the second housing has been opened in the lateral direction) (a state shown in FIG. 3). Incidentally, when making a phone call on the mobile telephone device 100, as a first operation step, the dialing buttons 8 are pressed to input a telephone number. As a second operation step, the telephone number displayed on the display 5 is to be confirmed. As a third operation step, the call button 3 is pressed. By the series of operations, the mobile telephone device 100 can be connected to another mobile telephone device through a telephone line via a base station and a mobile telephone network so as to start a talk with the holder of the other mobile telephone device. Then, when a voice communication is over, as a fourth operation step, the call clearing button 4 is pressed to cut off the telephone line. The series of operations is identical to operations implemented on a conventional mobile telephone device.

In addition to the operations described above, the call clear button 4 is used when switching on and off the mobile telephone device 100. For example, when the call clearing button 4 is kept pressed one second or longer with a power supply cut off, power is designed to be supplied to the mobile telephone device 100, and on the contrary, when the call clearing button 4 is kept pressed two seconds or longer with the power supplied to the mobile telephone device 100, the power supply is then cut off. This feature is identical to that of the conventional mobile telephone device.

As is shown in FIGS. 1 and 2, in the mobile telephone device 100, edge portions which constitute edge portions of the upper surface of the first housing 1 are chamfered in the vicinity of the call button 3 and the call clearing button 4 which are present on the upper surface of the first housing 1 so as to form elongated inclined surfaces 6. In addition, a linear projection 7b is formed on the inclined surface 6 lying in the vicinity of the call clearing button 4 (desirably, on the inclined surface 6 which lies laterally of the call clearing button 4 and on a side of the upper surface where the call clearing button 4 is provided as seen from a lateral center of the upper surface). In addition, a linear projection 7a is formed on the inclined surface 6 lying in the vicinity of the call button 3 (desirably, on the inclined surface 6 which lies laterally of the call button 3 and on a side of the upper surface where the call button 3 is provided as seen from the lateral center of the upper surface).

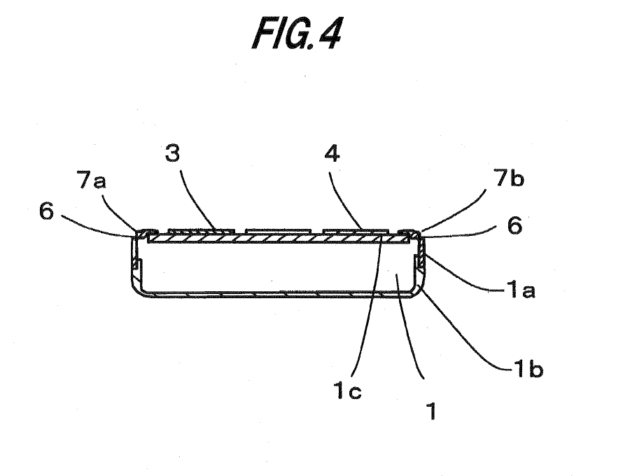

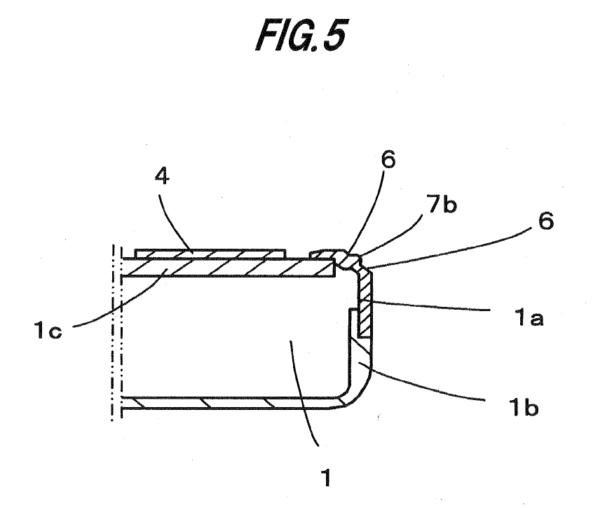

FIG. 4 shows a sectional view of the first housing 1 taken from line E-E of FIG. 3, and FIG. 5 shows an enlarged sectional view of part of the first housing 1. In FIGS. 4 and 5, the first housing 1 is made into a single housing by combining vertically an upper housing 1a and a lower housing 1b, and a control panel 1c is attached to the upper housing 1a. (The call button 3, the call clearing button 4, the dialing buttons 8 and the like are disposed on the control panel 1c). In addition, inclined surfaces 6 are formed on edge portions of an upper surface of the upper housing 1a of the first housing, and projections 7a, 7b are formed on the inclined surfaces 6 so formed, respectively. In addition, as is shown in FIGS. 1 and 2, longitudinal centers of the linear projections 7a, 7b are made to coincide with longitudinal centers of the call button 3 and the call clearing button 4, respectively. Namely, the projection 7b is provided on the inclined surface 6 which lies laterally of the call clearing button 4 and on the side of the upper surface where the clearing button 4 is provided as seen from the lateral center of the first housing 1. In addition, the projection 7a is provided on the inclined surface 6 which lies laterally of the call button 3 and on the side of the upper surface where the call button 3 is provided as seen from the lateral center of the first housing 1. Lengths of the linear projections 7a, 7b are made to match lengths of the call button 3 and the call clearing button 4 in their longitudinal direction, respectively. The lengths of the linear projections 7a, 7b may be longer or shorter than the longitudinal lengths of the call button 3 and the call clearing button 4, respectively. In addition, the projections 7a, 7b do not have to be linear and hence may each be formed as a single or a plurality of dot-like projections.

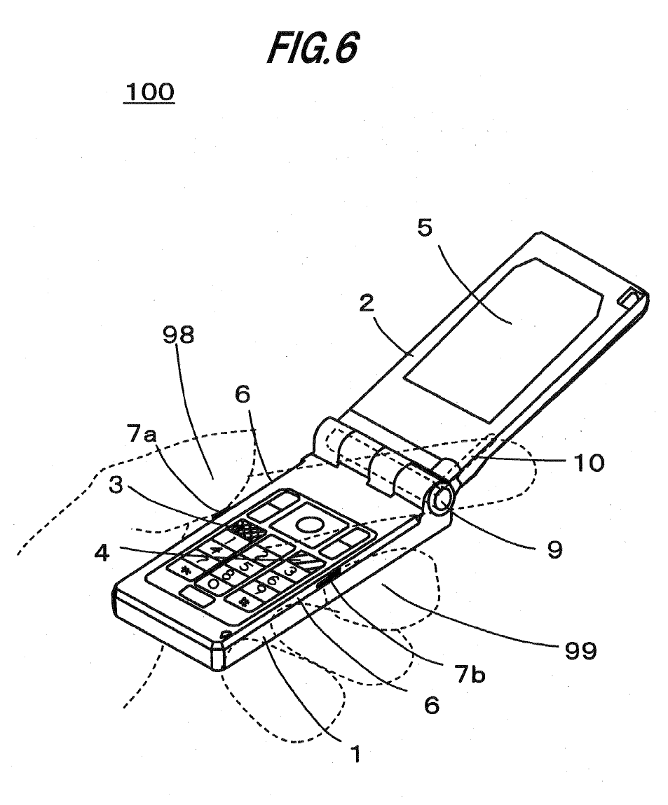

Since the projections 7a, 7b are present in positions which lie lower than the upper surface of the first housing 1, the projections 7a, 7b do not obstruct lateral opening and closing operations of the second housing 2 in which the second housing 2 is opened and closed in the lateral direction, and the operator can use the mobile telephone device 100 by touching the projections 7a, 7b so as to identify the call button 3 and the call clearing button 4. When holding the mobile telephone device 100 by the hand, the mobile telephone device 100 is normally gripped in such a manner that the fingers are brought into contact with side surfaces of the first housing. Because of this, since the projections 7a, 7b are provided on the inclined surfaces 6 formed on the edge portions which constitute the edge portions of the upper surface of the first housing 1, the fingers of the hand are made to easily touch the projections 7a, 7b. FIG. 6 shows a conceptual diagram showing a situation in which the mobile telephone device 100 is held by the left hand. In FIG. 6, the left hand is shown by broken lines. In FIG. 6, the thumb 98 touches the projection 7a provided on the inclined surface 6 of the first housing 1m and the middle finger 99 touches the projection 7b provided on the inclined surface 6 of the first housing 1. When a talk is carried out in such a state that the middle finger 99 is kept in contact with the projection 7b and then the talk is terminated, the call clearing button 4 can be pressed simply and quickly using the middle finger 99.

In addition to this, also when the power supply to the mobile telephone device is switched on by pressing the call clearing button 4, it is convenient that the projection 7b or the like is present in the way described above. For example, with the power supply to the mobile telephone device 100 switched on, the control panel 1c (the call button 3, the call clearing button 4, the dialing buttons 8 and the like) can be illuminated depending upon the brightness on the periphery of the user. However, with the power supply to the mobile telephone device 100 switched off, it is normal that the control panel is not illuminated. Because of this, when attempting to switch on the power supply to the mobile telephone device 100 at night or in a dark place, there may occur a situation in which the call clearing button 4 cannot be visualized well. However, even in such a case, with the mobile telephone device 100 of the embodiment, since the projection 7b lying laterally of the call clearing button 4 can easily be touched, the call clearing button 4 can quickly be pressed in an ensured fashion, so as to switch on the power supply to the mobile telephone device 100.

As has already been shown in FIG. 3, the second housing 2 on which the display 5 is present can be opened on the second hinge shaft 10 in the lateral direction. As has already been described, the elongated inclined surfaces 6 are formed by chamfering the edge portions in the vicinity of the call button 3 and the call clearing button 4 which are present on the upper surface of the first housing 1. Then, the linear projection 7b is provided on the inclined surface 6 lying near the call clearing button 4. In addition, the linear projection 7a is provided on the inclined surface 6 near the call button 3.

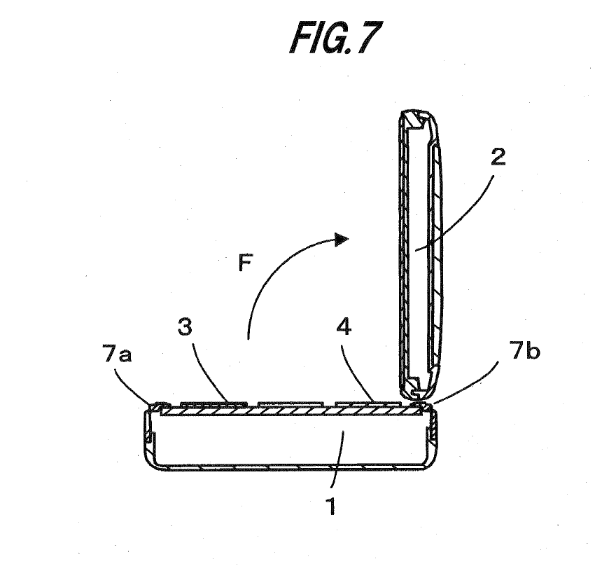

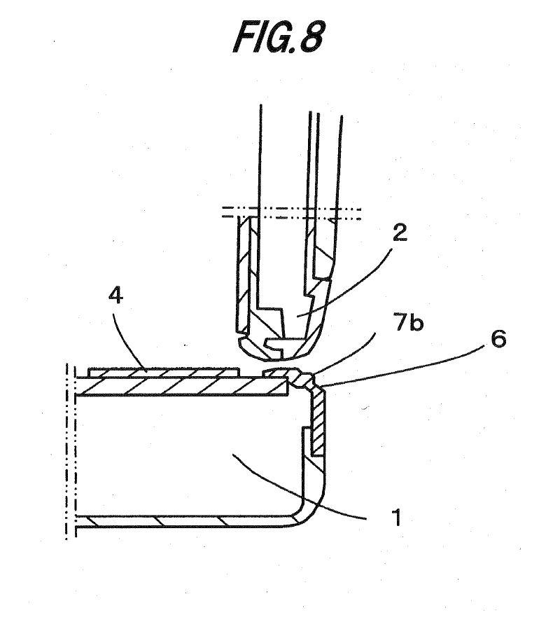

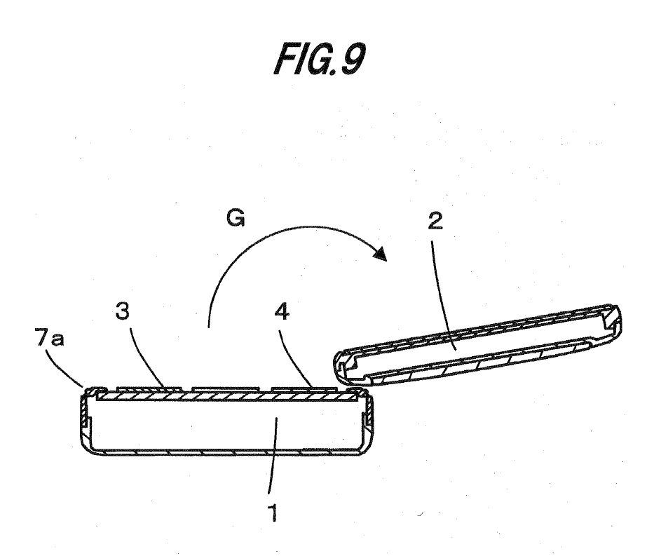

FIG. 7 shows a sectional view which results when the second housing 2 is opened laterally through on the order of 90 degrees. FIG. 8 shows a partial sectional view showing the vicinity of the call clearing button 4 and the projection 7b which results when the second housing 2 is opened laterally through on the order of 90 degrees. In addition, FIG. 9 shows a sectional view which results when the second housing 2 is opened laterally through on the order of about 170 degrees.

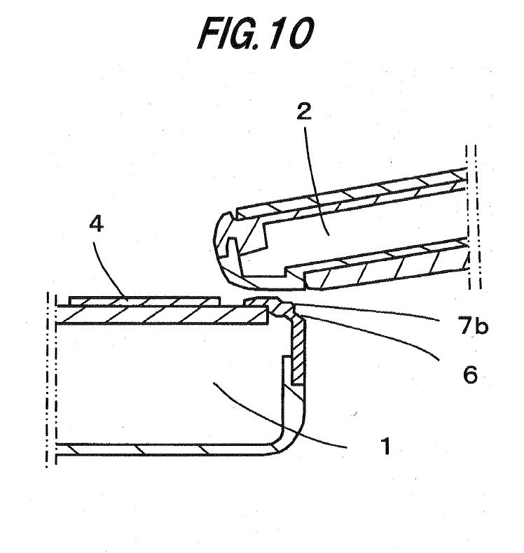

FIG. 10 shows a partial sectional view showing the vicinity of the call clearing button 4 and the projection 7b which results when the second housing 2 is opened laterally through on the order of about 170 degrees. Since the projections 7a, 7b lie in positions which are lower than the upper surface of the first housing 1, the projections 7a, 7b do not obstruct opening and closing operations of the second housing 2 in which the second housing 2 is opened in the lateral direction. Namely, the projection 7b which lies laterally of the call clearing button 4 does not touch the second housing 2 and hence, the projection 7b does not obstruct the opening of the second housing 2.

Note that when the mobile telephone device 100 is opened laterally, the projection 7b which identifies the call clearing button 4 is concealed by the second housing 2. However, originally, the second housing 2 is opened laterally to watch a TV program or the like on a laterally elongated screen, and hence, there will be no practical problem in use even in the event that the projection 7b is concealed.

Thus, as has been described heretofore, in the mobile telephone device 100 of Embodiment 1, when the second housing 2 is caused to rotate on the shaft which is parallel to the longitudinal direction of the first housing 1 and the second housing 2 in such a manner as to move away from the first housing 1 (when the second housing 2 is opened laterally), since the projection 7b is provided in the position lying lower than the height of the upper surface of the first housing 1, there occurs no situation in which the projection 7b lying laterally of the call clearing button 4 touches the second housing 2 to thereby obstruct the opening thereof. In addition, when the second housing 2 is caused to rotate on the shaft which is parallel to the lateral direction of the first housing 1 and the second housing 2 in such a manner as to move away from the first housing 1 (when the second housing 2 is opened longitudinally), since the projection 7b lying laterally of the call clearing button 4 can easily be touched, the call clearing button 4 can quickly be pressed in an ensured fashion.

In addition, in the mobile telephone device 100 of Embodiment 1, when attempting to switch on the power supply to the mobile telephone device 100 at night or in a dark place, even though the call clearing button 4 cannot be visualized well, since the projection 7b is provided on the edge portion which constitutes the edge portion of the upper surface of the first housing 1, the projection 7b lying laterally of the call clearing button 4 can easily be touched, and therefore, the call clearing button 4 can quickly be pressed in the ensured fashion, so as to switch on the power supply to the mobile telephone device 100 without any delay.

In addition, in the description made heretofore, although both the projections 7a, 7b which identify the call button 3 and the call clearing button 4, respectively, have been described as being disposed in the positions lying lower than the upper surface of the first housing 1, in the event that the projection 7a which identifies the call button 3 does not obstruct the opening of the second housing 2 even though it is disposed in a position lying higher than the upper surface of the first housing 1, a configuration may be adopted in which only the projection 7b which identifies the call clearing button 4 is disposed in the position lying lower than the upper surface of the first housing 1.

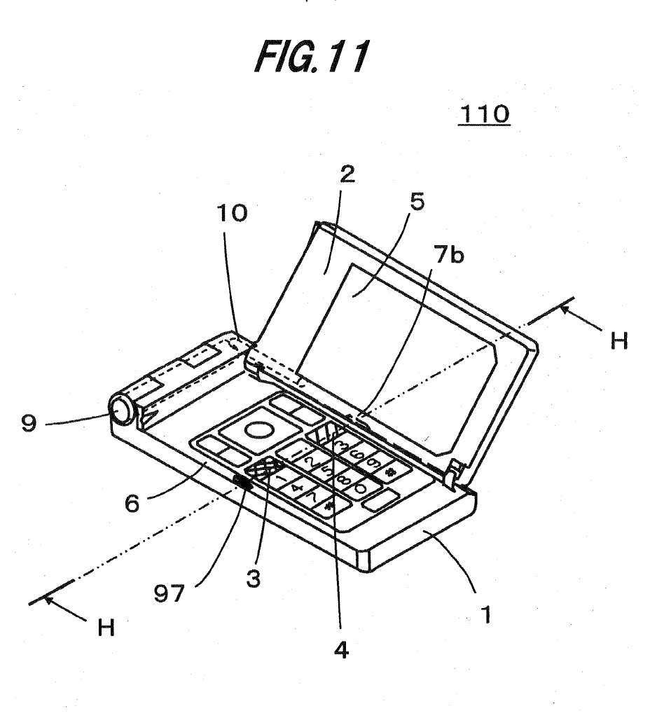

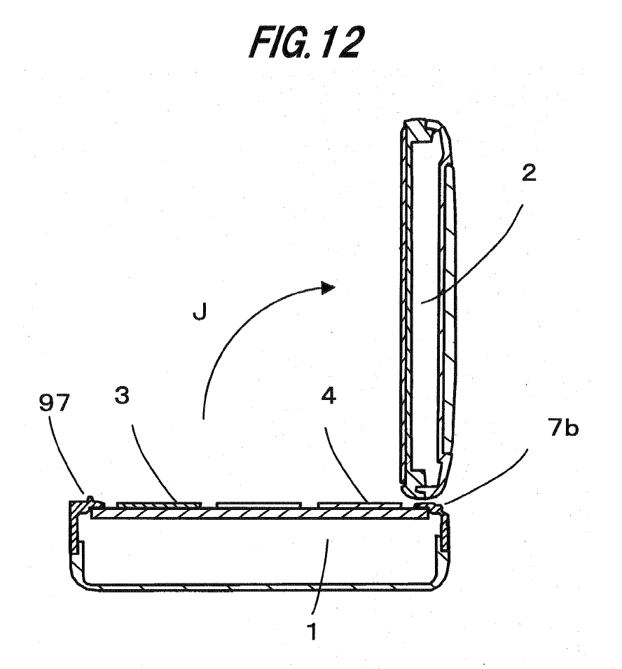

FIG. 11 shows a perspective view which results when a mobile telephone device 110 is opened laterally in which a projection 97 which identifies a call button 3 is disposed in a position lying higher than an upper surface of a first housing 1, while a projection 7b which identifies a call clearing button 4 is disposed in a position lying lower than the upper surface of the first housing 1. In addition, FIG. 12 shows a sectional view of the mobile telephone device 110 taken along the line H-H in FIG. 11. As is shown in FIG. 12, although the projection 97 which identifies the call button 3 is situated in the position which is higher than the upper surface of the first housing 1, the projection 97 does not obstruct the opening and closing of the second housing 2. On the other hand, since the projection 7b which identifies the call clearing button 4 is situated in the position which is lower than the upper surface of the first housing 1, the projection 7b does not obstruct the opening and closing of the second housing 2.

In this way, in the event that the projecting 97 which identifies the call button 3 and the projection 7b which identifies the call clearing button 4 are provided in the different positions, there is provided an advantage that when touched, the projections 97, 7b can easily be discriminated or identified.

In addition, in the description made heretofore, although the call clearing button 4 has been described as being disposed on the upper surface of the first housing 1 in the position lying on the side where the shaft is provided on which the second housing 2 is caused to rotate in such a manner as to move away from the first housing 1 and which is parallel to the longitudinal direction of the first housing 1 and the second housing 2 as seen from lateral center of the upper surface of the first housing 1, and the call button 3 has been described as being disposed on the upper surface of the first housing 1 in the position lying on the side which lies opposite to the side where the shaft is provided on which the second housing 2 is caused to rotate in such a manner as to move away from the first housing 1 and which is parallel to the longitudinal direction of the first housing 1 and the second housing 2 across the lateral center of the upper surface of the first housing 1, the positions of the call clearing button 4 and the call button 3 may be reversed. Namely, the call button 3 may be disposed on the upper surface of the first housing 1 in the position lying on the side where the shaft is provided on which the second housing 2 is caused to rotate in such a manner as to move away from the first housing 1 and which is parallel to the longitudinal direction of the first housing 1 and the second housing 2 as seen from the lateral center of the upper surface of the first housing 1, and the call clearing button 4 may be disposed on the upper surface of the first housing 1 in the position lying on the side which lies opposite to the side where the shaft is provided on which the second housing 2 is caused to rotate in such a manner as to move away from the first housing 1 and which is parallel to the longitudinal direction of the first housing 1 and the second housing 2 across the lateral center of the upper surface of the first housing 1.

In addition, as this occurs, both the projections which identify the call button 3 and the call clearing button 4, respectively, are disposed in positions which lie lower than the upper surface of the first housing 1 (or provided on inclined surfaces 6 similarly to the description made above). In the event that such a configuration is adopted, there occurs no situation in which the projection lying laterally of the call button 3 touches the second housing to thereby obstruct the opening of the second housing. In addition, when the second housing is caused to rotate on the shaft which is parallel to the lateral direction of the first housing and the second housing in such a manner as to move away from the first housing, since the projection lying laterally of the call button 3 can easily be touched, the call button 3 can quickly be pressed in an ensured fashion.

In addition, in the event that the projection which identifies the call clearing button 4 does not obstruct the opening of the second housing even though it is disposed in a position lying higher than the upper surface of the first housing 1, only the projection which identifies the call button 3 may be disposed in the position lying lower than the upper surface of the first housing 1. In the event that these configurations are adopted, the respective projections can easily be discriminated or identified.

### Embodiment 2

Next, as Embodiment 2 of the invention, a case will be described in which the invention is applied to a sliding mobile phone device.

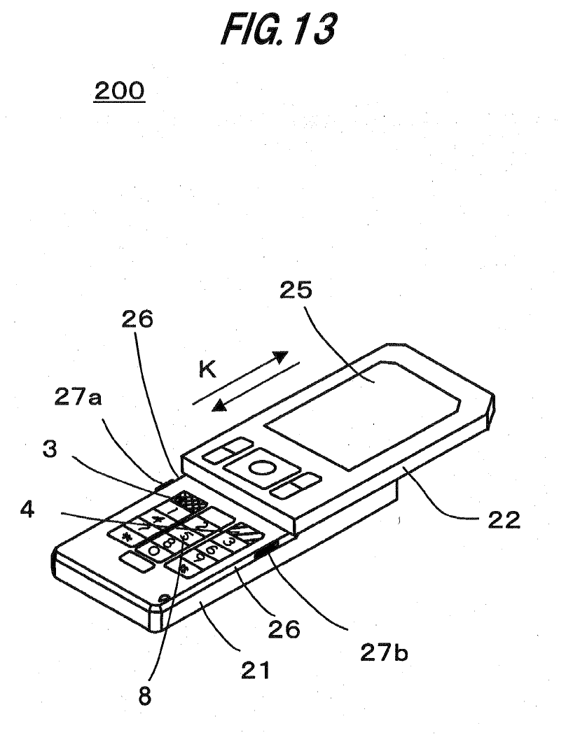

FIG. 13 is a perspective view showing an external appearance of a sliding mobile telephone device 200 according to Embodiment 2 of the invention. In the sliding mobile telephone device 200, a second housing 22 on which a display 25 is present slides over a first housing 21 on which a control part is present. Edge portions of an upper surface of the second housing 21 on which the control part is present are chamfered to form elongated inclines surfaces 26 in the vicinity of a call button 3 and a call clearing button 4 which are provided on the upper surface. In addition, a linear projection 27b is provided on the inclined surface 26 in the vicinity of the call clearing button 4.

Specifically, the projection 27b is provided on the edge portion which constitutes an edge portion of the upper surface of the first housing 21 which lies laterally of the call clearing button 4 and closer to a side of the upper surface where the call clearing button 4 is provided than a lateral center of the first housing 21 in such a manner as to be positioned lower than the height of the upper surface of the first housing 21.

In addition, a linear projection 27a is provided on the inclined surface 26 in the vicinity of the call button 3. Specifically, the projection 27a is provided on the edge portion which constitutes an edge portion of the upper surface of the first housing 21 which lies laterally of the call button 3 and on a side of the upper surface where the call button 3 is provided as seen from the lateral center of the first housing 21 in such a manner as to be positioned lower than the height of the upper surface of the first housing 21.

A sectional shape of the first housing 21 is similar to the sectional shape that has already been illustrated in FIGS. 4 and 5. The projections 27a, 27b are positioned lower than the upper surface of the first housing 21. Because of this, even though the second housing 22 slides over the first housing 21, the projections 27a, 27b are made not to touch a lower surface of the second housing 22 in any case. The projections 27a, 27b do not obstruct the sliding operation of the second housing 22. In addition, when the second housing 22 is kept open, the operator can touch the projections 27a, 27b so as to identify the call button 3 and the call clearing button 4 for use.

### Embodiment 3

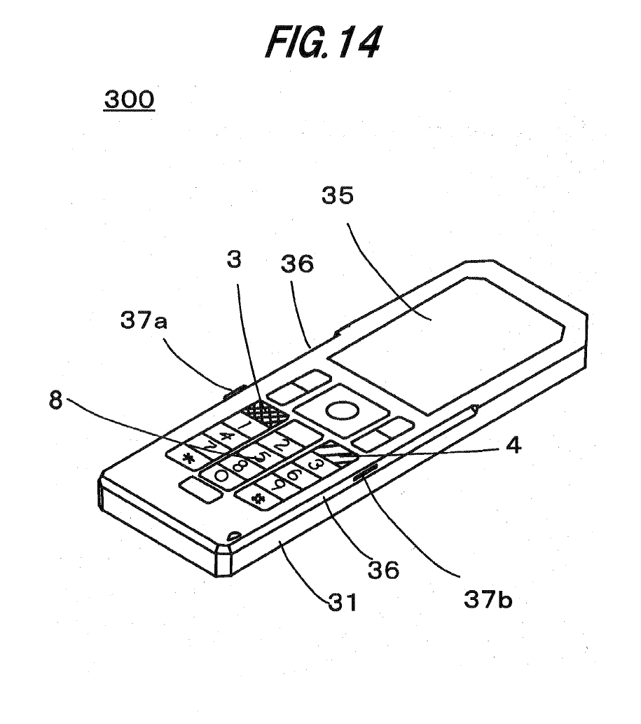

In Embodiment 3 of the invention, a case will be described in which the invention is applied to a so-called straight mobile telephone device. FIG. 14 is a perspective view showing an external appearance of a mobile telephone device 300 according to Embodiment 3 of the invention. In the mobile telephone device 300, a call button 3, a call clearing button 4, a display 35 and the like are provided on an upper surface of a housing 31 which is formed into a substantially rectangular parallelepiped shape.

In the mobile telephone device 300, edge portions of the upper surface of the housing 31 which lie in the vicinity of the call button 3 and the call clearing button 4 are chamfered, so as to form elongated inclined surfaces 36. In addition, a linear projection 37b is provided on the inclined surface 36 which lies in the vicinity of the call clearing button 4.

Specifically, the projection 37b is provided on the edge portion which constitutes an edge portion of the upper surface of the housing 31 which lies laterally of the call clearing button 4 and on a side of the upper surface where the call clearing button 4 is provided as viewed from a lateral center of the housing 31 in such a manner as to be positioned lower than the height of the upper surface of the housing 31.

In addition, a linear projection 37a is provided on the inclined surface 36 lying in the vicinity of the call button 3. Specifically, the projection 37a is provided on the edge portion which constitutes an edge portion of the upper surface of the housing 31 which lies laterally of the call button 3 and closer to a side of the upper surface where the call button 3 is provided than the lateral center of the housing 31 in such a manner as to be positioned lower than the height of the upper surface of the housing 31.

When the invention is applied to the straight mobile telephone device, the operator can touch the projections 37a, 37b so as to identify the call button 3 and the call clearing button 4 for use. In addition, since the projections 37a, 37b are positioned lower than the housing 31, the projections 37a, 37b are not caught on an entrance to a pocket on a pair of trousers or a shirt when attempting to put the mobile telephone device into the pocket, thereby making it possible to provide an advantage that the mobile telephone device can be accommodated in the desired place in a smooth fashion.

### Embodiment 4

Next, Embodiment 4 of the invention will be described. In Embodiment 4 of the invention, a call clearing button is disposed in the vicinity of an edge of an upper surface of a housing, stepped portions are formed on edge portions which constitute edge portions of the upper surface of the housing, and a projection which identifies a position where the call clearing button 4 is provided is disposed in the stepped portion of the housing in a position which lies in the vicinity of the call clearing button and lower than the upper surface of the housing.

In Embodiments 1 to 3 which have already been described, while the inclined surfaces are formed on the edge portions which constitute the edge portions of the upper surface of the housing and the projection which identifies the position of the call clearing button is provided on the inclined surface in the position which lies in the vicinity of the call clearing button and lower than the upper surface of the housing, Embodiment 4 of the invention is characterized in that not inclined surfaces but stepped portions 46 are formed on edge portions which constitute edge portions of the upper surface and in that a projection which identifies a position where the call clearing button is provided is provided in the stepped portion 46. Namely, the stepped portions 46 can be provided in place of the inclined surfaces of Embodiments 1 to 3 which have already been described.

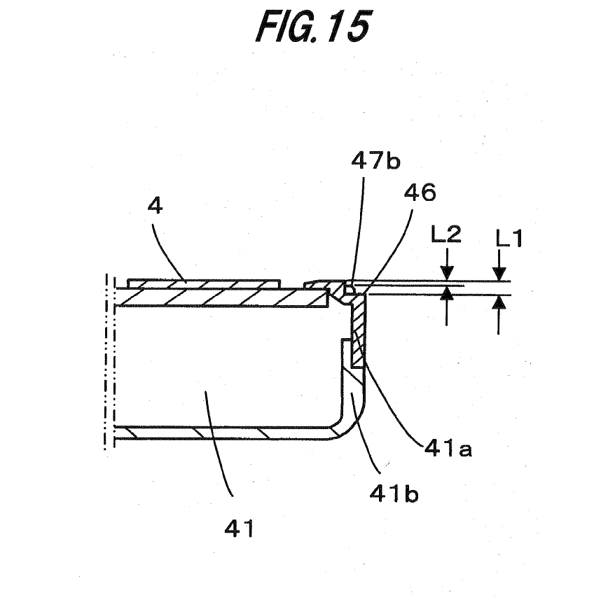

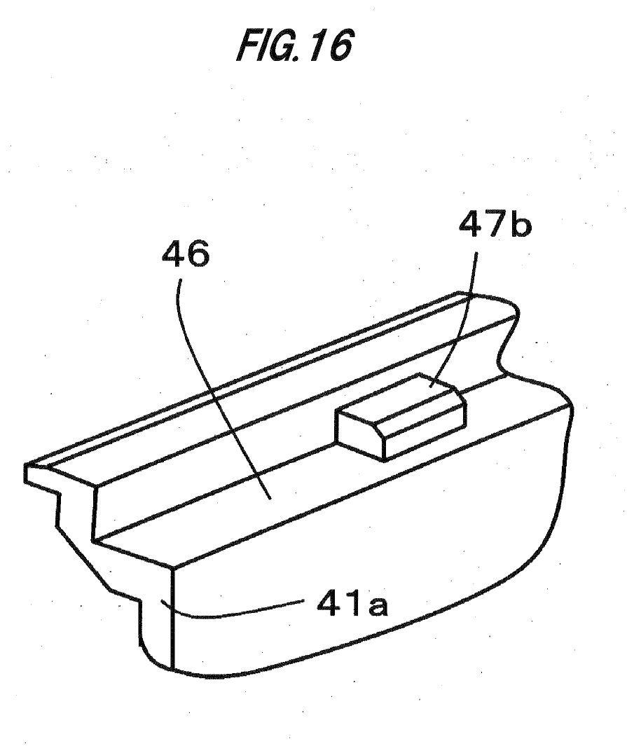

FIG. 15 shows a sectional view of a housing 41 of the mobile telephone device of Embodiment 4 of the invention. In addition, FIG. 16 shows a perspective view of part of an upper housing 41a. The stepped portion 46 is lowered by a difference in level “L1” from an upper surface of the housing 41, and the projection 47b is lowered by a difference in level “L2” from the upper surface of the housing 41. Since the difference in level “L1” of the stepped portion 46 is larger than the difference in level “L2” of the projection 47b, the finger gripping the mobile telephone device does not touch a surface of the stepped portion 46 but touches a surface of the projection 47b. When the finger touches the projection 47b, the operator comes to know a position where the projection 47b is provided and hence a position where a call clearing button 4 is provided.

According to the configuration described above, where the stepped portion 46 shown in FIGS. 15 and 16 is provided in place of, for example, the inclined surface 6 of Embodiment 1, since the projection 47b can be provided on the edge portion which constitutes an edge portion of the upper surface of the housing 41 (which corresponds to the first housing 1 of Embodiment 1) in the position lying lower than the height of the upper surface of the housing 41, in the case of the lateral opening described in Embodiment 1, there emerges no situation in which the projection 47b lying laterally of the call clearing button is brought into contact with the second housing 2 of Embodiment 1 to thereby obstruct the opening thereof. In the case of the longitudinal opening described in Embodiment 1, since the projection 47b lying laterally of the call clearing button can easily be touched, the call clearing button can quickly be pressed.

This will be true when the stepped portions 46 shown in FIGS. 15 and 16 are provided in place of the inclined surfaces 6 of Embodiment 2 or Embodiment 3.

### Embodiment 5

Next, Embodiment 5 of the invention will be described. Embodiment 5 of the invention is similar to Embodiments 1 to 3 in that a call clearing button is disposed in the vicinity of an edge of an upper surface of a housing, in that inclined surfaces are formed on edge portions of the upper surface of the housing and in that a projection which identifies a position where the call clearing button is provided is provided in a position lying in the vicinity of the call clearing button and lower than the upper surface of the housing but is characterized in that the inclined surfaces are formed into not a flat surface but a curved surface. Namely, a curved surface 56 can also be provided in place of the inclined surfaces of Embodiments 1 to 3 which have been described before.

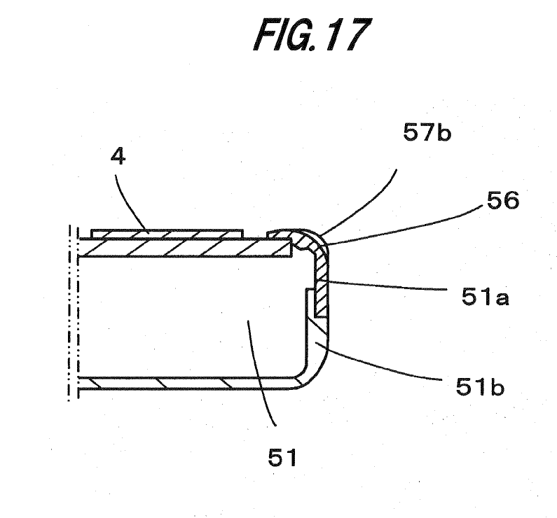

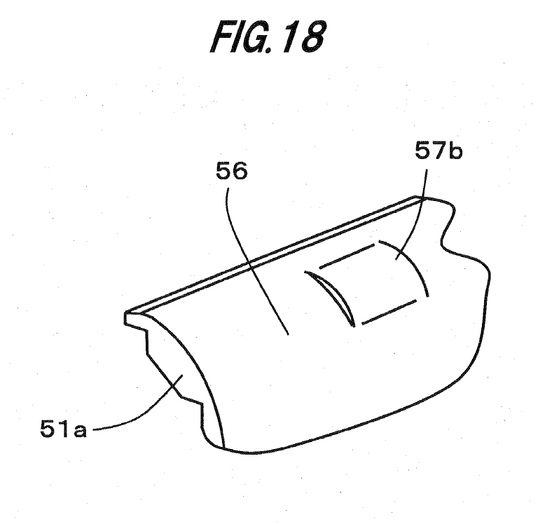

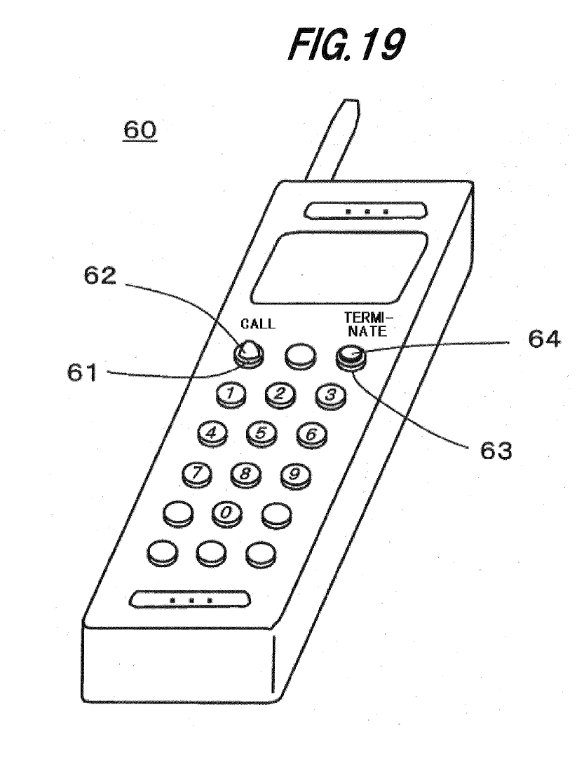

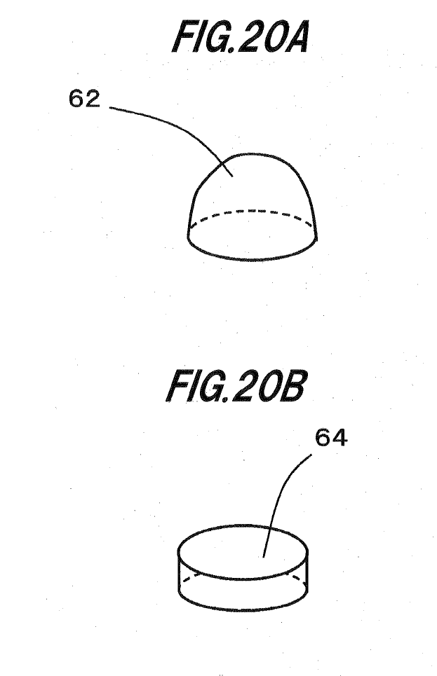

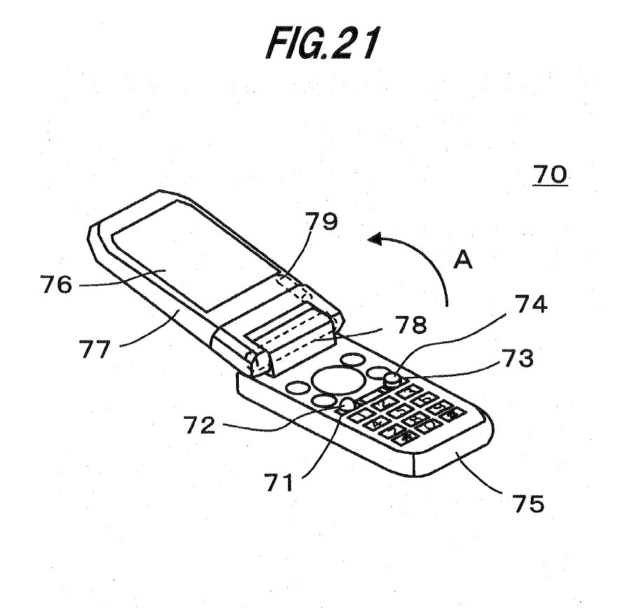

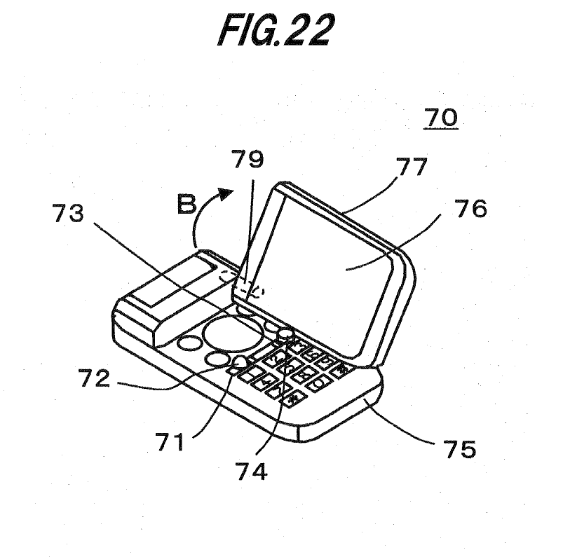

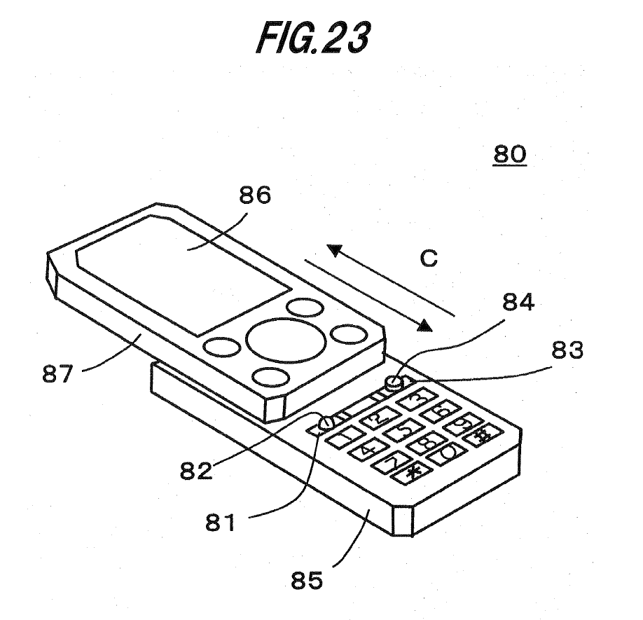

FIG. 17 shows a sectional view of a housing 51 of a mobile telephone device of Embodiment 5. In addition, FIG. 18 shows a perspective view of part of an upper housing 51a. In the mobile telephone device of Embodiment 5 of the invention, edge portions of the housing 51 are chamfered into an R shape so as to form a curved surface 56, so that the curved surface 56 so formed is made the inclined surface that has been described heretofore. In addition, part of the edge portion is chamfered into an R shape which has a smaller radius than a radius of the curved surface 56, so as to form a projection 57b. The projection 57b projects further than the curved surface 56. The finger gripping the mobile telephone device can identify a difference in level between the curved surface 56 and the projection 57b. Because of this, when the finger touches the projection 57b, the operator gets to know a position where the projection 57b is provided and hence a position where a call clearing button 4 is provided.

According to the configuration described above, where the curved portion 56 shown in FIGS. 15 and 16 is provided in place of, for example, the inclined surface 6 of Embodiment 1, since the projection 57b can be provided on the edge portion which constitutes an edge portion of the upper surface of the housing 51 (which corresponds to the first housing 1 of Embodiment 1) in the position lying lower than the height of the upper surface of the housing 51, in the case of the lateral opening described in Embodiment 1, there emerges no situation in which the projection 57b lying laterally of the call clearing button is brought into contact with the second housing 2 of Embodiment 1 to thereby obstruct the opening thereof. In the case of the longitudinal opening described in Embodiment 1, since the projection 57b lying laterally of the call clearing button can easily be touched, the call clearing button can quickly be pressed.

This will be true when the curved portions 56 shown in FIGS. 17 and 18 are provided in place of the inclined surfaces 6 of Embodiment 2 or Embodiment 3.

According to the invention, since the projection is provided in such a manner that the height thereof is made lower than the height of the upper surface of the housing, since the projection lying laterally of the call clearing button or the call button obstructs opening and the projection lying laterally of the call clearing button or the call button can easily be touched, the call clearing button or the call button can quickly be pressed in the ensured fashion, and therefore, the invention is useful for application to a mobile terminal device such as a mobile telephone device, PDA, PHS and the like in which the position of the call clearing button or the call button is made to be easily verified.

What is claimed is:

1. A foldable mobile terminal device in which a first housing is connected to a second housing via a connecting portion, comprising:
a first hinge shaft for opening/closing the second housing together with the connecting portion in a longitudinal direction;
a second hinge shaft for opening/closing the second housing in a lateral direction;
a call clearing button disposed on a second hinge shaft side of an upper surface of the first housing as seen from a lateral center of the upper surface; and
a first projection for button identification which is provided on an edge portion of the second hinge shaft side and lies lateral to the call clearing button wherein a height of the first projection is made lower than a height of the upper surface of the first housing.

2. The mobile terminal device as set forth in claim 1, further comprising:
a call button disposed on an opposite side of the second hinge shaft side of the upper surface as seen from the lateral center of the upper surface; and
a second projection for button identification which is provided on the opposite side of the second hinge shaft side and lies lateral to the call button.

3. The mobile terminal device as set forth in claim 1,
wherein the first housing has an inclined surface formed at the edge portion; and
wherein the first projection is provided on the inclined surface.

4. The mobile terminal device as set forth in claim 1,
wherein the first housing has a stepped portion formed at the edge portion; and
wherein the first projection is provided on the stepped portion.

5. The mobile terminal device as set forth in claim 1,
wherein the first housing has a curved surface portion formed at the edge portion; and
wherein the first projection is provided on the curved surface portion.

6. A foldable mobile terminal device in which a first housing is connected to a second housing via a connecting portion, comprising:
a first hinge shaft for opening/closing the second housing together with the connecting portion in a longitudinal direction;
a second hinge shaft for opening/closing the second housing in a lateral direction;
a call button disposed on a second hinge shaft side of an upper surface of the first housing as seen from a lateral center of the upper surface; and
a projection for button identification which is provided on an edge portion of the second hinge shaft side and lies lateral to the call button wherein a height of the first projection is made lower than a height of the upper surface of the first housing.

7. The mobile terminal device as set forth in claim 6,
wherein the first housing has an inclined surface formed at the edge portion; and
wherein the first projection is provided on the inclined surface.

8. The mobile terminal device as set forth in claim 6,
wherein the first housing has a stepped portion formed at the edge portion; and
wherein the first projection is provided on the stepped portion.

9. The mobile terminal device as set forth in claim 6,
wherein the first housing has a curved surface portion formed at the edge portion; and
wherein the first projection is provided on the curved surface portion.

10. A foldable mobile terminal device in which a first housing is connected to a second housing via a connecting portion, comprising:
a first hinge shaft for opening/closing the second housing together with the connecting portion in a longitudinal direction;
a second hinge shaft for opening/closing the second housing in a lateral direction;
a call clearing button disposed on an upper surface of the first housing;
a call button disposed on the upper surface of the first housing; and
a projection for button identification provided on an edge portion of the upper surface of the first housing,
wherein the call clearing button, the call button and the projection are disposed on a straight line in a lateral direction; and
wherein the projection is provided on the edge portion which lies at a side of the upper surface where the call clearing button is provided wherein a height of the projection is made lower than a height of the upper surface of the first housing.
